(19) United States
(12) Patent Application Publication
(10) Pub. No.: US 2023/0049166 A1
(43) Pub. Date: Feb. 16, 2023

(54) POLYMER COMPOSITION FOR FILMS HAVING IMPROVED MECHANICAL PROPERTIES AND DEGRADABILITY

(71) Applicant: NOVAMONT S.P.A., Novara (IT)

(72) Inventors: Catia BASTIOLI, Novara (IT); Sebastà GESTI GARCIA, Novara (IT); Patrizio SALICE, Novara (IT)

(21) Appl. No.: 17/788,419

(22) PCT Filed: Dec. 17, 2020
(86) PCT No.: PCT/EP2020/086872

§ 371 Date: Jun. 23, 2022

(30) Foreign Application Priority Data
Dec. 24, 2019 (IT) 102019000025471

(51) Int. Cl. C08L 67/02

(52) U.S. Cl. CPC C08L 67/02; C08L 2205/035

(57) ABSTRACT

Polymeric composition comprising, with respect to the total composition: i) 30-95% by weight, preferably between 50-85% by weight with respect to the sum of components i)-vi), of at least one polyester comprising: a) a dicarboxylic component comprising, with respect to the total of the dicarboxylic component: a1) 30-70% by moles of units deriving from at least one aromatic dicarboxylic acid; a2) 70-30% by moles of units deriving from at least one saturated aliphatic dicarboxylic acid; a3) 0-5% by moles of units deriving from at least one unsaturated aliphatic dicarboxylic acid; b) a diol component comprising, with respect to the total diol component: b1) 95-100% by moles of units deriving from at least one saturated aliphatic diol; b2) 0-5% by moles of units deriving from at least one unsaturated aliphatic diol; ii) 0.1-50% by weight with respect to the sum of components i)-vi), of at least one polymer of natural origin; iii) 0.1-10% by weight with respect to the sum of components i)-vi) of at least one polyhydroxy alkanoate different from a lactic acid polyester referred to in point iv); iv) 0-3% by weight with respect to the sum of components i)-vi) of at least one lactic acid polyester; v) 0-1% by weight, preferably 0-0.5% by weight, with respect to the sum of the components i)-vi) of at least one cross-linking agent and/or a chain extender and/or hydrolytic stabilizer comprising at least one compound di- and/or polyfunctional containing isocyanate, peroxide, carbodiimide, isocyanurate, oxazoline, epoxide, anhydride, diviniether groups and mixtures of these; vi) 0-15% by weight, with respect to the sum of components i)-vi), of at least one inorganic filling agent.

The project that led to the invention was funded by the Bio Based Industries Joint Undertaking Public-Private Partnership under the European Union's Horizon 2020 research and innovation programme, under Grant Agreement No. 720720.

This invention relates to a polymer composition that is particularly suitable for the production of films having improved mechanical properties and high degradability, which can be used for the manufacture of products such as bags for differentiated collection, shopping bags, food packaging, mulch films, nappies and hygiene items.

In the above application sectors there is a requirement for films that are characterised not only by good mechanical properties, but also high degradability at low temperature, which are therefore able to degrade without causing waste to accumulate in the environment once their primary use has been completed.

The polymer compositions currently on the market, made using aliphatic polyesters, in particular lactic acid polyesters, diacid-diol-type aliphatic-aromatic polyesters and polymers of natural origin such as starch, can be used to obtain films generally marked by good mechanical properties and biodegradability according to EN13432, with optimum degradability at high temperatures. Increasingly high disintegration rates are required even at temperatures below 58° C., which are typical of the composting process. This is because of the increased availability of composting plants with ever shorter cycles. Although compost quality, and therefore also its degree of maturity, are essential aspects for soil health, biodegradable bioplastics having a fast rate of disintegration will overcome the problems that inadequate composting plants could cause.

Patent EP 2 984 138 B1 describes biodegradable polymer mixtures comprising starch, an aliphatic-aromatic polyester, polylactic acid and polyhydroxyalkanoates (PHA). The use of high concentrations of PHA enables the content of renewable components in the mixture to be increased, but requires the presence of moderate concentrations of polylactic acid to give the material good mechanical properties.

Starting from the need to find a balance between improved mechanical properties and high degradability at low temperature, it has now surprisingly been found that it is possible to solve this problem through a polymer composition made with aliphatic-aromatic polyesters and polymers of natural origin in which the polyesters of lactic acid are partly or wholly replaced by at least one polyhydroxyalkanoate. This substitution in the composition leads to an increase in the low temperature degradability of the films obtained, and maintains, if not improves, their mechanical properties.

The present invention relates in particular to a polymer composition comprising, with respect to the total composition:
i) 30-95% by weight, preferably 50-85% by weight, with respect to the sum of components i)-vi), of at least one polyester comprising:
   a) a dicarboxylic component comprising, with respect to the total dicarboxylic component:
      a1) 30-70% in moles, preferably 40-60% in moles, of units derived from at least one aromatic dicarboxylic acid;
      a2) 70-30% in moles, preferably 60-40% in moles, of units derived from at least one saturated aliphatic dicarboxylic acid;
      a3) 0-5% in moles of units derived from at least one saturated aliphatic dicarboxylic acid;
   b) a diol component comprising, with respect to the total diol component:
      b1) 95-100% in moles of units deriving from at least one saturated aliphatic diol;
      b2) 0-5% in moles of units deriving from at least one unsaturated aliphatic diol;
ii) 0.1-50% by weight, preferably 5-40% by weight, with respect to the sum of components i)-vi), of at least one polymer of natural origin,
iii) 0.1-10% by weight, preferably 0.1-8% by weight, even more preferably 0.1-6% by weight, with respect to the sum of components i)-vi), of at least one polyhydroxyalkanoate other than a polyester of lactic acid mentioned in point iv);
iv) 0-3% by weight, preferably 0-2.9% by weight, even more preferably 0-2% by weight, even more preferably 0-1% by weight, with respect to the sum of components i)-vi), of at least one polyester of lactic acid,
v) 0-1% by weight, preferably 0-0.5% by weight, with respect to the sum of components i)-vi), of at least one cross-linking agent and/or chain extender comprising at least one compound having two and/or multiple functional groups including isocyanate, peroxide, carbodiimide, isocyanurate, oxazoline, epoxide, anhydride, divinyl ether groups and mixtures thereof,
vi) 0-15% by weight, with respect to the sum of components i)-vi), of at least one inorganic filler.

The composition according to the present invention is rapidly biodegradable under industrial composting conditions according to EN 13432 and more preferably in home composting, according to UNI 11355, and in soil, according to EN 17033.

The composition according to the present invention comprises 30-95% by weight, preferably 50-85% by weight, with respect to the sum of components i)-vi), of at least one aliphatic-aromatic polyester i). Said aliphatic-aromatic polyesters comprise a dicarboxylic component which comprises, with respect to the total dicarboxylic component, 30-70% in moles, preferably 40-60% in moles of units derived from at least one aromatic dicarboxylic acid (component a1), and 70-30% in moles, preferably 60-40% in moles of units derived from at least one saturated aliphatic dicarboxylic acid (component a2).

The aromatic dicarboxylic acids (component a1) of aliphatic-aromatic polyesters i) of the composition according to the present invention are preferably selected from aromatic dicarboxylic acids of the phthalic acid type, preferably terephthalic acid or isophthalic acid, more preferably terephthalic acid, and heterocyclic dicarboxylic aromatic compounds, preferably 2,5-furandicarboxylic acid, 2,4-furandicarboxylic acid, 2,3-furandicarboxylic acid, 3,4-furandicarboxylic acid, their esters, salts and mixtures.

In a preferred embodiment, said aromatic dicarboxylic acids comprise:
1 to 99% in moles, preferably 5 to 95% and more preferably 10 to 80%, of terephthalic acid, its esters or salts;
99 to 1% in moles, preferably 95 to 5% and more preferably 90 to 20%, of 2,5-furandicarboxylic acid, its esters or salts.

In another preferred embodiment, said aromatic dicarboxylic acids are selected from among only aromatic dicarboxylic acids of the phthalic acid type.

The saturated aliphatic dicarboxylic acids (component a2) of aliphatic-aromatic polyesters i) are instead preferably selected from C2-C24, preferably C4-C13, more preferably C4-C11, saturated dicarboxylic acids, their C1-C24, preferably C1-C4, alkyl esters, their salts and mixtures thereof. Preferably, the saturated aliphatic dicarboxylic acids are selected from: succinic acid, 2-ethylsuccinic acid, glutaric acid, 2-methylglutaric acid, adipic acid, pimelic acid, suberic acid, azelaic acid, sebacic acid, undecandioic acid, dodecandioic acid, brassylic acid and their C1-C24 alkyl esters.

Preferably said saturated dicarboxylic acids are selected from the group consisting of succinic acid, adipic acid, azelaic acid, sebacic acid, undecandioic acid, dodecandioic acid, brassylic acid and their mixtures.

The dicarboxylic component of aliphatic-aromatic polyesters in the composition according to the present invention may comprise up to 5% of unsaturated aliphatic dicarboxylic acids (component a3), preferably selected from itaconic acid, fumaric acid, 4-methylene-pimelic acid, 3,4-bis(methylene) nonandioic acid, 5-methylene-nonandioic acid, their C1-C24, preferably C1-C4, alkyl esters, their salts and mixtures thereof. In a preferred embodiment of the present invention the unsaturated aliphatic dicarboxylic acids comprise mixtures comprising at least 50% in moles, preferably more than 60% in moles, preferably more than 65% in moles of itaconic acid and/or its C1-C24, preferably C1-C4, esters. More preferably, the unsaturated aliphatic dicarboxylic acids consist of itaconic acid.

The diol component of aliphatic-aromatic polyesters i) of the composition according to the present invention includes, in comparison with the total diol component, 95-100% in moles, preferably 97-100% in moles, of units derived from at least one saturated aliphatic diol (component b1) and 0-5% in moles, preferably 0-3% in moles, in comparison with the total diol component, of units derived from at least one unsaturated aliphatic diol (component b2).

The saturated aliphatic diols (component b1) of aliphatic-aromatic polyesters i) of the composition according to the present invention are preferably selected from 1,2-ethanediol, 1,2-propanediol, 1,3-propanediol, 1,4-butanediol, 1,5-pentanediol, 1,6-hexanediol, 1,7-heptanediol, 1,8-octanediol, 1,9-nonanediol, 1,10-decanediol, 1,11-undecanediol, 1,12-dodecanediol, 1.13-tridecanediol, 1,4-cyclohexanediethanol, neopentylglycol, 2-methyl-1,3-propanediol, dianhydrosorbitol, dianhydromannitol, dianhydroiditol, cyclohexanediol, cyclohexanmethanediol, dialkyleneglycols and polyalkylene glycols of molecular weight 100-4000 such as polyethylene glycol, polypropylene glycol and mixtures thereof. Preferably, the diol component comprises at least 50% in moles of one or more diols selected from 1,2-ethanediol, 1,3-propanediol, 1,4-butanediol. In a preferred embodiment of the present invention, the saturated aliphatic diol is 1,4-butanediol.

The unsaturated aliphatic diols (component b2) of aliphatic-aromatic polyesters i) of the composition according to the present invention are preferably selected from cis 2-buten-1,4-diol, trans 2-buten-1,4-diol, 2-butyn-1,4-diol, cis 2-penten-1,5-diol, trans 2-penten-1,5-diol, 2-pentyn-1,5-diol, cis 2-hexen-1,6-diol, trans 2-hexen-1,6-diol, 2-hexyn-1,6-diol, cis 3-hexen-1,6-diol, trans 3-hexen-1,6-diol, 3-hexyn-1,6-diol.

In a preferred embodiment aliphatic-aromatic polyesters i) are preferably selected from: poly(1,4-butylene adipate-co-1,4-butylene terephthalate), poly(1,4-butylene succinate-co-1,4-butylene terephthalate), poly(1,4-butylene sebacate-co-1,4-butylene terephthalate), poly(1,4-butylene azelate-co-1,4-butylene terephthalate), poly(1,4-butylene brassylate-co-1,4-butylene terephthalate), poly(1,4-butylene adipate-co-1,4-butylene sebacate-co-1,4-butylene terephthalate), poly(1,4-butylene undecanoate-co-1,4-butylene terephthalate, poly(1,4-butylene dodecanoate-co-1,4-butylene terephthalate, poly(1,4-butylene azelate-co-1,4-butylene sebacate-co-1,4-butylene terephthalate), poly(1,4-butylene adipate-co-1,4-butylene azelate-co-1,4-butylene terephthalate), poly(1,4-butylene succinate-co-1,4-butylene sebacate-co-1,4-butylene terephthalate), poly(1,4-butylene adipate-co-1,4-butylene succinate-co-1,4-butylene terephthalate), poly(1,4-butylene azelate-co-1,4-butylene succinate-co-1,4-butylene terephthalate) and mixtures thereof.

In a preferred embodiment aliphatic-aromatic polyesters i) are preferably selected from: poly(1,4-butylene adipate-co-1,4-butylene terephthalate), poly(1,4-butylene sebacate-co-1,4-butylene terephthalate) and poly(1,4-butylene azelate-co-1,4-butylene terephthalate). and mixtures thereof.

In another preferred embodiment of the invention, poly(1,4-butylene adipate-co-1,4-butylene azelate-co-1,4-butylene terephthalate) is mixed with one or more polyesters selected from poly(1,4-butylene adipate-co-1,4-butylene terephthalate), poly(1,4-butylene sebacate-co-1,4-butylene terephthalate) and poly(1,4-butylene azelate-co-1,4-butylene terephthalate).

In an even more preferred embodiment of the invention, poly(1,4-butylene adipate-co-1,4-butylene terephthalate) is mixed with one or more polyesters selected from poly(1,4-butylene adipate-co-1,4-butylene azelate-co-1,4-butylene terephthalate), poly(1,4-butylene sebacate-co-1,4-butylene terephthalate) and poly(1,4-butylene azelate-co-1,4-butylene terephthalate).

In an even more preferred embodiment, aliphatic-aromatic polyester i) is poly(1,4-butylene adipate-co-1,4-butylene terephthalate).

Aliphatic-aromatic polyesters i) may also advantageously comprise repetitive units derived from at least one hydroxy acid in quantities between 0-49%, preferably between 0-30% in moles with respect to the total moles of dicarboxylic component.

Examples of convenient hydroxy acids are glycolic acid, hydroxybutyric acid, hydroxycaproic acid, hydroxyvaleric acid, 7-hydroxyheptanoic acid, 8-hydroxyheptanoic acid, 9-hydroxynonanoic acid, lactic acid or lactides. The hydroxy acids can be inserted in the chain as such or as prepolymers/oligomers, or they may also previously be reacted with diacids or diols.

Long molecules with two functional groups may also be added, in quantities not exceeding 10% in moles with respect to the total moles of the dicarboxylic component, even with functional groups not in terminal positions. Examples are dimer acids, ricinoleic acid and acids including an epoxy functional group and also polyoxyethylenes of molecular weight between 200 and 10000.

Diamines, amino acids and amino alcohols may also be present in percentages up to 30% in moles with respect to the total moles of dicarboxylic component.

In the process for preparing aliphatic-aromatic polyesters i) of the composition according to the present invention, one or more molecules with multiple functional groups may also advantageously be added in quantities between 0.1 and 3% in moles with respect to the total moles of dicarboxylic component (as well as possibly hydroxy acids), in order to obtain branched products. Examples of these molecules are glycerol, pentaerythritol, trimethylolpropane, citric acid, dipentaerythritol, monoanhydrosorbitol, monohydromannitol, acid triglycerides, polyglycerols, etc.

The molecular weight Mn of polyester i) is preferably ≥20000, more preferably ≥40000. As far as the polydispersity index of the molecular weights Mw/Mn is concerned, this is preferably between 1.5 and 10, more preferably between 1.6 and 5 and even more preferably between 1.8 and 2.7.

The molecular weights Mₙ and M_{w} can be measured using Gel Permeation Chromatography (GPC). The determination may be carried out with the chromatographic system held at 40° C. using a set of two columns in series (5 μm and 3 μm particle diameter with mixed porosity), a refractive index detector, chloroform as eluent (flow 0.5 ml/min) and polystyrene as reference standard.

The Melt Flow Rate (MFR) of aliphatic-aromatic polyesters i) is preferably between 500 and 1 g/10 min, more preferably between 100 and 3 g/10 min, even more preferably between 15 and 3 g/10 min (measurement made at 190° C./2.16 kg according to ISO 1133-1 “Plastics-determination of the melt mass-flow rate (MFR) and melt volume flow rate (MVR) of thermoplastics—Part 1: Standard method”).

The terminal acid groups content of polyester i) is preferably below 100 meq/kg, preferably below 60 meq/kg and even more preferably below 40 meq/kg.

The terminal acid groups content may be measured as follows: 1.5-3 g of polyester are placed in a 100 ml flask together with 60 ml of chloroform. After complete dissolution of the polyester, 25 ml of 2-propanol are added and, immediately before the analysis, 1 ml of deionised water. The solution thus obtained is titrated with a previously standardised solution of NaOH in ethanol. An appropriate indicator such as a glass electrode for acid-base titration in non-aqueous solvents is used to determine the titration end point. The content of terminal acid groups is calculated on the basis of the consumption of NaOH solution in ethanol according to the following equation:

$$Terminal acid groups content ( meq / kg of polymer ) = \frac{⌊ ( {V}_{eq} - {V}_{b} ) \cdot T ⌋ \cdot 1000}{P}$$

where: Veq=ml of NaOH solution in ethanol at the sample titration end point;
Vb=ml of NaOH solution in ethanol necessary to reach pH=9.5 in the blank titration;
T=concentration of NaOH solution in ethanol expressed in moles/litre;
P=weight of the sample in grams.

Preferably, polyester i) has an inherent viscosity (measured with Ubbelohde viscometer for CHCl3 solutions in a concentration of 0.2 g/dl at 25° C.) of more than 0.3 dl/g, preferably between 0.3 and 2 dl/g, more preferably between 0.4 and 1.1 dl/g.

Preferably polyester i) is biodegradable. According to the present invention, a biodegradable polymer is a biodegradable polymer according to EN 13432.

Said polyester i) can be synthesised according to any of the processes known in the prior art.

In particular, it may advantageously be obtained through a polycondensation reaction.

The synthesis process may advantageously be carried out in the presence of a suitable catalyst.

Examples of suitable catalysts include organometallic tin compounds such as stannoic acid derivatives, titanium compounds such as orthobutyl titanate, aluminium compounds such as triisopropyl aluminium, or compounds of antimony and zinc and zirconium and mixtures thereof.

Examples of synthesis processes that can be advantageously used for the preparation of polyesters are described in international patent application WO 2016/050963.

The composition according to the present invention comprises 0.1-50% by weight, preferably 5-40% by weight with respect to the sum of components i)-vi), at least one polymer of natural origin (ii).

In the composition according to the present invention the polymer of natural origin is advantageously selected from starch, chitin, chitosan, alginates, proteins such as gluten, zein, casein, collagen, gelatin, natural gums, cellulose (also in nanofibrils) and pectin.

The term starch is used here to refer to all types of starch, i.e.: flour, native starch, hydrolysed starch, destructured starch, gelatinised starch, plasticised starch, thermoplastic starch, biofillers including complexed starch or mixtures thereof. According to the invention starches such as potato, corn, tapioca and pea starch are particularly suitable.

Starches that can be easily deconstructed and have high initial molecular weights, such as potato or corn starch, are particularly advantageous.

The starch may be present both as such and in chemically modified form, such as starch esters with a degree of substitution between 0.2 and 2.5, hydroxypropylated starch, modified starch with fatty chains.

Destructured starch refers here to the teachings contained in Patents EP 0 118240 and EP 0 327 505, as such meaning starch processed in such a way that it does not substantially show the so-called “maltese crosses” under a polarised light microscope and the so-called “ghosts” under a phase contrast light microscope.

Starch destructuration is advantageously carried out by means of an extrusion process at temperatures between 110 and 250° C., preferably 130-180° C., pressures between 0.1 and 7 MPa, preferably 0.3-6 MPa, preferably providing a specific energy of more than 0.1 kWh/kg during said extrusion.

Starch destructuration takes place preferably in the presence of 1-40% by weight, with respect to the weight of starch, of one or more plasticisers chosen from water and polyols having from 2 to 22 carbon atoms. As far as water is concerned, this may also be the water naturally present in the starch. Preference is given to polyols having 1 to 20 hydroxyl groups containing 2 to 6 carbon atoms, their ethers, thioethers and organic and inorganic esters.

Examples of polyols are glycerol, diglycerol, polyglycerol, pentaerythritol, polyglycerol ethoxylate, ethylene glycol, polyethylene glycol, 1,2-propanediol, 1,3-propanediol, 1,4-butanediol, neopentylglycol, sorbitol, sorbitol monoacetate, sorbitol diacetate, sorbitol monoethoxylate, sorbitol diethoxylate, and mixtures thereof. In a preferred embodiment starch is destructured in the presence of glycerol or a mixture of plasticisers comprising glycerol, preferably between 2 and 90% by weight of glycerol. Preferably, destructured and cross-linked starch according to the present invention comprises between 1 and 40% by weight of plasticisers, with respect to the weight of starch.

When present, starch in the composition according to the present invention is preferably in the form of particles having a circular, elliptical or otherwise ellipse-like cross-section with an arithmetic mean diameter, measured taking into account the major axis of the particle, of less than 1 micron and more preferably less than 0.5 μm mean diameter.

In addition to components i) and ii), the composition according to the present invention comprises 0.1-10% by weight, preferably 0.1-8% by weight, more preferably 0.1-6% by weight, with respect to the sum of components i)-vi), of at least one polyhydroxyalkanoate (component iii) other than a polyester of lactic acid mentioned in point iv).

In the present invention polyhydroxyalkanoate (component iii) means that it is a polyhydric fatty acid containing monomers having a chain of at least four (4) carbon atoms.

Therefore, the acid lactic polyester is not a polyhydroxyalkanoate according to the invention, while polyhydroxybutyrate (PHB), for instance, is.

According to the present invention a polyhydroxyalkanoate (iii) comprising repetitive monomer units according to the following formula (1) has to be considered preferred:

[O—CHR—(CH₂)ₘ—CO—] (1)

wherein R is H or an alkyl group having formula CₙH₍₂ₙ₊₁₎, n is an integer number comprised between 1 and 15, preferably between 1 and 6, and m is an integer number comprised between 1 and 4.

Said polyhydroxyalkanoate (component iii) is selected preferably from the group consisting of poly-F-caprolactone, polyhydroxybutyrate, polyhydroxybutyrate-valerate, polyhydroxybutyrate-propanoate, polyhydroxybutyrate-hexanoate, polyhydroxybutyrate-decanoate, polyhydroxybutyrate-dodecanoate, polyhydroxybutyrate-hexadecanoate, polyhydroxybutyrate-hexadecanoate, polyhydroxybutyrate-octadecanoate, poly 3-hydroxybutyrate 4-hydroxybutyrate.

More preferably said polyhydroxyalkanoate is selected from the group consisting of polyhydroxybutyrate (PHB), polyhydroxybutyrate-valerate (PHBV) and polyhydroxybutyrate-hexanoate (PHBH). Even more preferably said polyhydroxyalkanoate is polyhydroxybutyrate-valerate.

Polyhydroxybutyrate-valerate (PHBV) as described in formula (2) is particularly preferred.

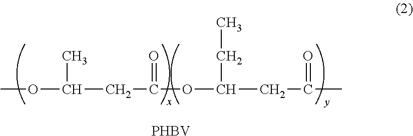

In a further preferred aspect of the present invention the hydroxybutyrate (co-monomer x) is higher than 95% by moles with respect to the sum of all the co-monomers (x+y), preferably from 96% to 100% by moles The presence of a high molar content of a co-monomer different from hydroxybutyrate in the polymeric chain of polyhydroxybutyrate gives place to a decrease of fusion temperature so increasing the difference between fusion temperature and degradation temperature and consequently improving the processability.

In the present invention the “fusion temperature” means the maximum of the endothermic peak corresponding to the fusion of the polyhydroxyalkanoate determined by Differential Scanning Calorimetry (DSC) during the heating scansion at 20° C./min from −20° C. to 200° C.

In the present invention the “degradation temperature” means the onset starting temperature determined by Thermogravimetric Analysis (TGA).

The onset starting temperature is calculated as the intersection of the tangents to the offset point from the initial weight to the inflection point of the termogravimetric curve carrying out the analysis at a heating speed of 10° C./min in nitrogen atmosphere.

Surprisingly, in the present invention the use of polyhydroxyalkanoate with low molar content of a co-monomer different from hydroxybutyrate, even if they are less stable from a thermic point of view with respect those having a higher content, shows a better balance between mechanical properties and tear strength.

In addition to components i)-iii), the composition according to the present invention comprises a quantity ≤3% by weight, preferably <2.9% by weight, even more preferably <2.5% by weight, yet more preferably <2% by weight, and even more preferably <1% with respect to the sum of components i)-vi) of at least one polyester of lactic acid (component iv).

In a preferred embodiment, lactic acid polyesters are selected from the group consisting of poly L-lactic acid, poly D-lactic acid, poly D-lactic acid stereo complex, copolymers comprising more than 50% in moles of said lactic acid polyesters or mixtures thereof. Particularly preferred are lactic acid polyesters containing at least 95% by weight of repetitive units derived from L-lactic or D-lactic acid or their combinations, with a molecular weight Mw of more than 50000 and a shear viscosity of between 50 and 700 Pa·s, preferably between 80 and 500 Pa·s (measured according to ASTM standard D3835 at T=190° C., shear rate=1000s-1, D=1 mm, L/D=10).

In a particularly preferred embodiment of the present invention, the lactic acid polyester comprises at least 95% by weight of L-lactic acid units, ≤5% of repetitive L-lactic acid units, has a melting point in the range 135-175° C., a glass transition temperature (Tg) in the range 55-65° C. and an MFR (measured according to ASTM-D1238 at 190° C. and 2.16 kg) in the range 1-50 g/10 min. Commercial examples of lactic acid polyesters having these properties are Ingeo™ brand products Biopolymer 4043D, 3251D and 6202D. 0-1%, more preferably 0-0.5% by weight, with respect to the weight of components i)-vi), of at least one cross-linking agent and/or chain extender and/or hydrolytic stabiliser (component v) may also be present in the composition according to the present invention in order to improve stability to hydrolysis.

Said cross-linking agent and/or chain extender is selected from compounds having two or multiple functional groups including isocyanate, peroxide, carbodiimide, isocyanurate, oxazoline, epoxide, anhydride, divinyl ether groups and mixtures thereof.

Particularly preferred are mixtures of compounds having two or multiple functional groups including isocyanate groups with compounds having two or multiple functional groups including epoxy groups, even more preferably comprising at least 75% by weight of compounds having two or multiple functional groups including isocyanate groups.

The compounds having two or multiple functional groups including isocyanate groups are preferably selected from phenylene diisocyanate, 2,4-toluene diisocyanate, 2,6-toluene diisocyanate, 4,4-diphenylmethane diisocyanate, 1,3-phenylene-4-chloro diisocyanate, 1,5-naphthalene diisocyanate, 4,4-diphenylene diisocyanate, 3,3′-dimethyl-4,4-diphenylmethane diisocyanate, 3-methyl-4,4′-diphenylmethane diisocyanate, diphenylester diisocyanate, 2,4-cyclohexane diisocyanate, 2,3-cyclohexane diisocyanate, 1-methyl-2,4-cyclohexyl diisocyanate, 2,6-cyclohexyl diisocyanate, bis(cyclohexyl isocyanate) methane, 2,4,6-toluene triisocyanate, 2,4,4-diphenylether triisocyanate, polymethylene-polyphenyl-polyisocyanates, methylene diphenyl diisocyanate, triphenylmethane triisocyanate, 3,3′-diitolene-4,4-diisocyanate, 4,4′-methylene bis (2-methylphenyl isocyanate), hexamethylene diisocyanate, 1,3-cyclohexylene diisocyanate, 1,2-cyclohexylene diisocyanate and mixtures thereof.

In a preferred embodiment the compound including isocyanate groups is 4,4-diphenylmethane diisocyanate.

As regards compounds having two or multiple functional groups including peroxide groups, these are preferably selected from benzoyl peroxide, lauroyl peroxide, isononanoyl peroxide, di(t-butylperoxyisopropyl)benzene, t-butyl peroxide, dicumyl peroxide, alpha,alpha′-di(t-butylperoxy)diisopropylbenzene, 2,5-dimethyl-2,5di(t-butylperoxy)hexane, t-butyl cumyl peroxide, di-t-butyl peroxide, 2,5-dimethyl-2,5-di(t-butylperoxy)hex-3-yne, di(4-t-butylcyclohexyl)peroxydicarbonate, dicetyl peroxydicarbonate, dimyristyl peroxydicarbonate, 3,6,9-trimethyl-3,6,9-trimethyl-1,4,7-triperoxonane, di(2-ethylhexyl) peroxydicarbonate and mixtures thereof. The compounds having two or multiple functional groups including carbodiimide groups which are preferably used in the composition according to the present invention are selected from poly(cyclo-octylene carbodiimide), poly(1,4-dimethylenecyclohexylene carbodiimide), poly(cyclohexylene carbodiimide), poly(ethylene carbodiimide), poly(butylene carbodiimide), poly(isobutylene carbodiimide), poly(nonylene carbodiimide), poly(dodecylene carbodiimide), poly(neopentylene carbodiimide), poly(1,4-dimethylene phenylene carbodiimide), poly(2,2′,6,6′-tetraisopropyldiphenylene carbodiimide) (Stabaxol® D), poly(2,4,6-triisolpropyl-1,3-phenylene carbodiimide) (Stabaxol® P-100), poly(2,6-diisopropyl-1,3-phenylene carbodiimide) (Stabaxol® P), poly(tolyl carbodiimide), poly(4,4′-diphenylmethane carbodiimide), poly(3,3′-dimethyl-4,4′biphenylene carbodiimide), poly(p-phenylene carbodiimide), poly(m-phenylene carbodiimide), poly(3,3′-dimethyl-4,4′-diphenylmethane carbodiimide), poly(naphthylene carbodiimide), poly(isophorone carbodiimide), poly(cumene carbodiimide), p-phenylene bis(ethyl carbodiimide), 1,6-hexamethylene bis(ethyl carbodiimide), 1,8- octamethylene bis(ethyl carbodiimide), 1,10-decamethylene bis(ethyl carbodiimide), 1,12-dodecamethylene bis(ethyl carbodiimide) and mixtures thereof.

Examples of compounds having two or multiple functional groups including epoxy groups that can advantageously be used in the composition according to the present invention are all polyepoxides from epoxidised oils and/or styrene-glycidylether-methyl methacrylate, glycidylether-methyl methacrylate, within a range of molecular weights of between 1000 and 10000 and with a number of epoxy groups per molecule in the range from 1 to 30 and preferably between 5 and 25, the epoxides being selected from the group comprising: diethylene glycol diglycidyl ether, polyethylene glycol diglycidyl ether, polyglycidyl ether glycerol, polyglycidyl ether diglycerol, 1,2-epoxybutane, polyglycidyl ether polyglycerol, isoprene diepoxide, and cycloaliphatic epoxides, 1,4-cyclohexandimethanol diglycidyl ether, glycidyl 2-methylphenyl ether, glycerol propoxylatotriglycidyl ether, 1,4-butanediol diglycidyl ether, sorbitol polyglycidyl ether, glycerol diglycidyl ether, tetraglycidyl meta-xylenediamine ether and diglycidyl bisphenol A ether and mixtures thereof.

Together with compounds having two or multiple functional groups including isocyanate, peroxide, carbodiimide, isocyanurate, oxazoline, epoxide, anhydride and divinylether groups such as those described above, catalysts may also be used to increase the reactivity of the reactive groups. In the case of polyoxides, salts of fatty acids are preferably used, even more so calcium and zinc stearates.

In a particularly preferred embodiment of the invention, the crosslinking agent and/or chain extender comprises compounds including isocyanate groups, preferably 4,4-diphenylmethane diisocyanate, and/or including carbodiimide groups, and/or including epoxy groups, preferably of the styrene-glycidylether methyl methacrylate type.

In addition to components i)-v) of the composition according to the invention, said composition also comprises 0-15% by weight, with respect to the weight of components i)-vi) of at least one inorganic filler (component vi), preferably selected from kaolin, barytes, clay, talc, calcium and magnesium carbonates, iron and lead carbonates, aluminium hydroxide, diatomaceous earth, aluminium sulfate, barium sulfate, silica, mica, titanium dioxide, wollastonite. In a preferred embodiment of the present invention the inorganic filler comprises talc, calcium carbonate or mixtures thereof, present in the form of particles with an arithmetic mean diameter, measured along the major axis of the particle, of less than 10 microns. In fact, it has been discovered that fillers of the type mentioned above that are not characterised by said arithmetic mean diameter do not improve the degradability characteristics of the objects that include them in industrial composting.

If calcium carbonate and talc are present at the same time as inorganic fillers, the calcium carbonate will be between 0.1 and 9% by weight, with respect to the weight of components i)-vi).

In the composition according to the present invention one or more other components may advantageously be present, in addition to components i-vi) mentioned above. In this case the composition comprises components i-vi) and preferably one or more polymers other than components i)-iv), of synthetic or natural origin, whether biodegradable or not, as well as possibly one or more other components.

With regard to polymers other than components i)-iv) of synthetic or natural origin, whether biodegradable or not, these are advantageously selected from the group consisting of vinyl polymers, diacid-diol polyesters other than polyester i), polyamides, polyurethanes, polyethers, polyureas, polycarbonates and mixtures thereof.

Among the vinyl polymers, those preferred are: polyethylene, polypropylene, their copolymers, polyvinyl alcohol, polyvinyl acetate, polyethyl vinyl acetate and polyethylene vinyl alcohol, polystyrene, chlorinated vinyl polymers, polyacrylates.

In addition to polyvinyl chloride, chlorinated vinyl polymers are here to be understood to be polyvinylidene chloride, poly(vinyl chloride-vinyl acetate), poly(vinyl chloride-ethylene), poly(vinyl chloride-propylene), poly(vinyl chloride-styrene), poly(vinyl chloride-isobutylene) and copolymers in which polyvinyl chloride represents more than 50% in moles.

Said copolymers may be random, block or alternating copolymers.

With regard to the polyamides of the composition according to the present invention, these are preferably selected in the group consisting of polyamide 6 and 6,6, polyamide 9 and 9,9, polyamide 10 and 10,10, polyamide 11 and 11,11, polyamide 12 and 12,12 and their combinations of the 6/9, 6/10, 6/11, 6/12 type, their blends and copolymers, both random and block copolymers.

Preferably, the polycarbonates of the composition according to the present invention are selected from the group consisting of polyalkylene carbonates, more preferably polyethylene carbonates, polypropylene carbonates, polybutylene carbonates, their mixtures and copolymers, both random and block copolymers.

Among the polyethers, those preferred are selected from the group consisting of polyethylene glycols, polypropylene glycols, polybutylene glycols, their copolymers and mixtures with molecular weights from 70000 to 500000.

As for the diacid-diol polyesters other than polyester i), these preferably comprise:
g1) a dicarboxylic component comprising, with respect to the total dicarboxylic component:
   g1) 20-100% in moles of units derived from at least one aromatic dicarboxylic acid,
   g2) 0-80% in moles of units derived from at least one saturated aliphatic dicarboxylic acid,
   g3) 0-5% in moles of units derived from at least one unsaturated aliphatic dicarboxylic acid;
h) a diol component comprising, with respect to the total diol component:
   h1) 95-100% in moles of units from at least one saturated aliphatic diol;
   h2) 0-5% in moles of units from at least one unsaturated aliphatic diol.

Preferably, aromatic dicarboxylic acids g1), saturated aliphatic dicarboxylic acids g2), unsaturated aliphatic dicarboxylic acids g3), saturated aliphatic diols h1) and unsaturated aliphatic diols h2) for said polyesters are selected from those described above for polyester i) of the composition according to the present invention.

In addition to the components mentioned above, the composition according to the present invention preferably also contains at least one further component selected from the group consisting of plasticisers, UV stabilisers, lubricants, nucleating agents, surfactants, antistatic agents, pigments, flame retardants and compatibility agents, lignin, organic acids, antioxidants, mould prevention agents, waxes, process coadjuvants and polymer components selected preferably from the group consisting of vinyl polymers, diacid-diol polyesters other than the aliphatic-aromatic polyester described above, polyamides, polyurethanes, polyethers, polyureas, polycarbonates.

As far as plasticisers are concerned, in addition to the plasticisers preferably used for the preparation of deconstructed starch as described above, the composition according to the present invention contains one or more plasticisers selected from the group consisting of phthalates, such as diisononyl phthalate, trimellitates, such as trimellitic acid esters with C4-C20 mono-alcohols preferably selected from the group consisting of n-octanol and n-decanol, and aliphatic esters having the following structure:

R₁—C(O)—R₄—C(O)—[—O—R₂—O—C(O)—R₅—C(O)—]_{z}—O—R₃

where:

R₁ is selected from one or more of the groups formed by H, linear and branched saturated and unsaturated alkyl residues of the C1-C24 type, polyol residues esterified with C1-C24 monocarboxylic acids;

R₂ comprises —CH2-C(CH3)2—CH2— and C2-C8 alkylene groups, and consists of at least 50% in moles of said —CH2-C(CH3)2—CH2—groups;

R₃ is selected from one or more of the groups formed by H, linear and branched saturated and unsaturated alkyl residues of the C1-C24 type, polyol residues esterified with C1-C24 monocarboxylic acids;

R₄ and R₅ are the same or different and comprise one or more C2-C22, preferably C2-C11, more preferably C4-C9, alkylenes and consist at least 50% in moles of C7 alkylenes.

z is an integer between 1 and 20, preferably 2 and 10, more preferably 3 and 7.

Preferably, in said esters at least one of the R₁ and/or R₃ groups comprises residues of polyols esterified with at least one C1-C24 monocarboxylic acid selected from the group consisting of stearic acid, palmitic acid, 9-ketostearic acid, 10-ketostearic acid and mixtures thereof, preferably in quantities ≥10% in moles, more preferably ≥20% in moles, even more preferably ≥25% in moles, with respect to the total quantity of R₁ and/or R₃ groups. Examples of aliphatic esters of this type are described in Italian patent application MI2014A000030 and international patent applications WO 2015/104375 and WO 2015/104377.

When present, the selected plasticisers are preferably present up to 10% by weight, with respect to the total weight of the composition.

Lubricants are preferably selected from metal esters and salts of fatty acids such as zinc stearate, calcium stearate, aluminium stearate and acetyl stearate. Preferably the composition according to the present invention comprises up to 1% by weight of lubricants, more preferably up to 0.5% by weight, with respect to the total weight of the composition.

Examples of nucleating agents include saccharin sodium salt, calcium silicate, sodium benzoate, calcium titanate, boron nitride, isotactic polypropylene, low molecular weight PLA. Slipping agents are e.g. biodegradable fatty acid amides such as oleamide, erucamide, ethylene-bis-stearylamide, fatty acid esters such as glycerol oleates or glycerol stearates, saponified fatty acids such as stearates.

These additives are preferably added in quantities of up to 10% by weight and more preferably between 2 and 6% by weight, with respect to the total weight of the composition.

Pigments may also be added if necessary, e.g. titanium dioxide, clays, copper phthalocyanine, titanium dioxide, silicates, iron oxides and hydroxides, carbon black, and magnesium oxide.

These additives will preferably be added up to 10% by weight.

The composition according to the invention is extremely suitable for use in many practical applications for the production of products such as films, preferably blown films, also multilayer films, characterised by a high degree of disintegration at low temperatures, accompanied by very good mechanical properties.

Preferably, the disintegration of films comprising the composition according to the present invention takes place in home composting, at a temperature of 28° C.±2, and the degree of disintegration is determined visually by periodical observations. Preferably, films comprising the composition according to the present invention are no longer visible after 180 days.

By virtue of the high degree of disintegration at low temperatures and the very good mechanical properties, the films comprising the composition according to the present invention find application in the production of mulch films, being able to effectively perform their action of protecting the soil, for example preventing the growth of weeds and reducing water consumption, but without needing to be removed at the end of use.

Preferably, disintegration of the films comprising the composition according to the present invention takes place in soil, at a temperature of 28° C.±2, and the degree of disintegration is determined visually by periodical observations. Preferably, films comprising the composition according to the present invention will no longer be visible after disintegration for 120 days, more preferably 90 days.

The film made with the composition according to the present invention is biodegradable according to EN 13432. Preferably, said film is biodegradable in home composting according to UNI 11355 and in soil according to EN 17033.

The film made with the composition according to the present invention advantageously has a thickness of less than 40 μm, preferably less than 30 μm, even more preferably less than 15 μm.

As far as mechanical properties are concerned, films made with the composition according to the invention have a tensile strength >15 MPa, preferably >20 MPa, elongation at break >200%, elastic modulus >200 MPa, determined according to the method in ASTM standard D882 (tensile properties at 23° C. and relative humidity of 55% and Vo=50 mm/min).

Preferably, film made with the composition according to the present invention is characterised by a tear strength in the machine direction >80 N/mm, tear strength in the transverse direction >150 N/mm (determined according to the ASTM D1922 method at 23° C. and 55% relative humidity).

The composition according to the invention may advantageously be used in cast extrusion processes.

The compositions according to the present invention also find application in the agricultural textile sector.

The present invention also relates to articles comprising the composition according to the present invention.

Examples of products comprising the composition according to the present invention are:
films, both mono- and bi-oriented, and multi-layer films with other polymer materials;
film for use in the agricultural sector as mulch films;
fabric for use in the agricultural sector as an agricultural textile;
films for use in the hygiene sector such as for nappies, liners for tampons, etc.;
stretch film as well as cling film for food, for bales in agriculture and for wrapping waste;
bags and liners for organic collections such as the collection of food waste and grass cuttings;
bags for fruit and vegetables and shopping bags;
composites with gelatinised, destructured and/or complexed starch, natural starch, flours, other natural, vegetable or inorganic fillers.

The invention will now be illustrated with a few example embodiments which are to be understood to be examples and will not limit the scope of protection of this patent application.

### EXAMPLES

### Example 1

Preparation of the Components of the Polymer Mixture According to the Invention

Component i)

i-a=Poly(1,4-butylene adipate-co-1,4-butylene terephthalate) (“PBAT”) prepared according to the following method: 7453 g of terephthalic acid, 7388 g of adipic acid, 12033 g of 1,4-butanediol, 4.4 g of glycerine and 3.4 g of an 80% by weight ethanol solution of diisopropyl triethanolamine titanate (Tyzor TE, containing 8.2% by weight of titanium), in a molar diol/dicarboxylic acid (MGR) ratio of 1.40, were loaded into a steel reactor with a geometric capacity of 60 litres, equipped with a mechanical stirring system, a nitrogen inlet, a distillation column, a knockdown system for high boiling distillates and a connection to a high vacuum system. The temperature of the mass was raised gradually to 230° C. over 120 minutes. When 95% of the theoretical water had been distilled, 17.0 g of tetra n-butyl titanate was added (corresponding to 119 ppm of metal with respect to the amount of poly(1,4-butylene adipate-co-1,4-butylene terephthalate) theoretically obtainable by converting all the adipic acid and terephthalic acid fed to the reactor). The reactor temperature was then raised to 235-240° C. and the pressure was gradually reduced to below 2 mbar within 60 minutes. The reaction was allowed to proceed for the time necessary to obtain a poly(1,4-butylene adipate-co-1,4-butylene terephthalate) with an MFR of about 6.5 (g/10 minutes at 190° C. and 2,16 Kg), and then the material was discharged in the form of rods into a water bath and granulated.

i-b=Poly(1,4-butylene sebacate-co-1,4-butylene terephthalate-co-1,4-butylene furan-2,5-dicarboxylate) (“PBSTF”) prepared according to the following method: 6414 g of terephthalic acid, 2009 g of 2,5-furandicarboxylic acid, 6939 g of sebacic acid, 10820 g of 1,4-butanediol, 3.95 g glycerine and 3.4 g of an 80% by weight ethanol solution of diisopropyl triethanolamine titanate (Tyzor TE, containing 8.2% by weight of titanium) were loaded, in a molar diol/dicarboxylic acid (MGR) ratio of 1.40, into a steel reactor with a geometric capacity of 60 litres, equipped with a mechanical stirring system, a nitrogen inlet, a distillation column, a knockdown system for high boiling distillates and a connection to a high vacuum system. The temperature of the mass was raised gradually to 235° C. over 120 minutes. When 95% of the theoretical water had been distilled, 17.0 g of tetra n-butyl titanate was added (corresponding to 119 ppm metal with respect to the amount of poly (1,4-butylene sebacate-co-1,4-butylene terephthalate-co-1,4-butylene furan-2,5-dicarboxylate) theoretically obtainable by converting all the sebacic acid, 2,5-furandicarboxylic acid and terephthalic acid fed to the reactor). The reactor temperature was then raised to 235-240° C. and the pressure was gradually reduced to below 2 mbar within 60 minutes. The reaction was allowed to proceed for the time necessary to obtain a poly(1,4-butylene sebacate-co-1,4-butylene terephthalate-co-1,4-butylene furan-2,5-dicarboxylate) with an MFR of about 22 (g/10 minutes at 190° C. and 2.16 kg), and then the material was discharged into a water bath in the form of rods and granulated.

Component ii)

ii=native maize starch and plasticiser (75.7% by weight native maize starch, 12.3% by weight polyglycerol and 12.0% added water)

Component iii)

iii=polyhydroxybutyrate-valerate (“PHBV”) Enmat Y1000P, MFR (190° C. and 2.16 kg)=14.4 g/10 min. It contains 1.6% moles of 3 hydroxyvalerate units.

Component iv)

iv=Polylactic acid (“PLA”) Luminy LX175, MFR (190° C. and 2.16 kg)=3.5/10 min.

Component v)

v-a=a styrene-glycidylether-methyl methacrylate copolymer with a molecular weight Mw of approximately 14000 and an equivalent weight of epoxy groups of 420 g/eq.

v-b=HMV-15CA Carbodilite manufactured by Nisshinbo Chemical Inc.

### Example 2

Granule Characterisation, Filming Process and Mechanical Characterisation

The compositions shown in Table 1 were fed to a twin-screw APV 2030 co-rotating extruder (L/D=40; diameter 30 mm), operating under the following conditions:
rpm: 170
capacity: 10 kg/h
thermal profile: 30-90-140-150-200×9-170×3° C.
open degassing.

The granules thus obtained showed the MFR value (190° C.; 2.16 kg) shown in Table 2 according to ISO 1133-1 “Plastics—determination of the melt mass-flow rate (MFR) and melt volume flow rate (MVR) of thermoplastics—Part 1: Standard method”).

The granules thus obtained were fed to a Ghioldi model bubble film machine with a 40 mm diameter screw and L/D 30 operating at 64 rpm with a 120-140-170×2 thermal profile. The film-forming head with an air gap of 0.9 mm and L/D 12 was set at 155° C. Film forming was carried out with a blowing ratio of 3 and a stretch ratio of 14 in order to obtain a film with a thickness of 20 μm. The film was then subjected to mechanical characterisation (film tensile strength according to ASTM D882 at 23° C., 55% relative humidity −Vo 50 mm/min). Tear strength tests were performed according to ASTM D1922 (at 23° C. and 55% relative humidity).

### Example 3

Film Disintegration Process

Disintegration under home composting conditions was carried out according to UNI standard 11355 App. A, whereas disintegration in soil was carried out at a temperature of 28±2° C. using a fertile soil and compost according to ISO17556.

In both cases the degree of disintegration of the films comprising the composition according to the present invention was determined by inserting the 5×5 cm samples in the slides. The slides were placed over a first layer of soil or compost (depending on the test) of about 4 cm and then covered with a second layer of about 2 cm of soil or compost. The slides were periodically observed and photographed to check the degree of disintegration. A degree of disintegration was attributed according to an empirical scale:

| | |
|---|---|
| degree of disintegration gd = 0 | Film unchanged |
| degree of disintegration gd = 1 | Film with very few (1-2) |
| | holes-tears, etc. |
| degree of disintegration gd = 2 | Film with widespread tears |
| | but structure still intact |
| degree of disintegration gd = 3 | Film with degraded areas |
| | and widespread breaks, loss |
| | of structure |
| degree of disintegration gd = 4 | Film with very few residues |
| | recoverable with difficulty |
| degree of disintegration gd = 5 | Film completely disintegrated, |
| | no longer visible |

### Example 4

Description of Compositions

Further to what has been described in example 1, different polymer compositions according to the invention and different comparison compositions were prepared.

Table 1 describes the various compositions that were then fed into the extruder

TABLE 1
Compositions fed into the extruder

| | Components % | | | | | | |
|---|---|---|---|---|---|---|---|
| | i | | | | | v | |
| Compositions | i-a | i-b | ii | iii | iv | v-a | v-b |
| Composition 1 | 71.26 | 0 | 24.14 | 4.01 | 0 | 0.15 | 0.20 |
| Comparative | 71.26 | 0 | 24.14 | 0 | 4.01 | 0.15 | 0.20 |
| composition 1 | | | | | | | |
| Composition 2 | 61.26 | 0 | 32.01 | 6.13 | 0 | 0.20 | 0.15 |
| Comparative | 61.26 | 0 | 32.01 | 0 | 6.13 | 0.20 | 0.15 |
| composition 2 | | | | | | | |
| Composition 3 | 71.26 | 0 | 24.14 | 3.03 | 0.98 | 0.15 | 0.20 |
| Composition 4 | 64.26 | 5 | 26.14 | 4.01 | 0 | 0.15 | 0.20 |

0.24% by weight, with respect to the sum of components i)-vi), of a process adjuvant, Atmer SA 1753, was added to all the compositions.

Table 2 describes the rheological properties of the compositions and the water content of the granules as a percentage by weight based on the total composition after the extrusion process.

TABLE 2
Properties of the granules obtained

| | MFR (160° C., | Final granule |
|---|---|---|
| | 5 kg) | water content |
| Compositions | (g/10 min) | %) |
| Composition 1 | 5.4 | 0.6 |
| Comparative composition 1 | 4.6 | 0.5 |
| Composition 2 | 4.9 | 0.7 |
| Comparative composition 2 | 4.3 | 0.6 |
| Composition 3 | 4.6 | 0.6 |
| Composition 4 | 5.2 | 0.7 |

### Example 5

Results of Tests on Mechanical Properties

The different compositions described in example 4 were tested as described in example 2.

The results are shown in Table 3.

TABLE 3
Properties of films of thickness of 20 μm
with the compositions shown in Table 1

| | Mechanical properties | | | Tear strength | |
|---|---|---|---|---|---|
| | σb | εb | E | (N/mm) | |
| Compositions | (MPa) | (%) | (MPa) | MD | TD |
| Composition 1 | 38.7 | 529 | 259 | 92 | 193 |
| Comparative | 29.6 | 439 | 199 | 99 | 104 |
| composition 1 | | | | | |
| Composition 2 | 25.4 | 464 | 293 | 191 | 253 |
| Comparative | 25.2 | 399 | 298 | 180 | 134 |
| composition 2 | | | | | |
| Composition 3 | 29.3 | 543 | 223 | 113 | 210 |
| Composition 4 | 28.5 | 417 | 205 | 82 | 74 |

As can be seen, the compositions according to the invention not only show a general improvement in mechanical properties, but also have a surprisingly improved effect on the tear strength of the film in the transverse direction.

### Example 6

Film Disintegration Test Results

The different compositions described in example 4 were tested as described in example 3.

The results are given in Tables 4 and 5.

TABLE 4
Disintegration of films including the compositions
shown in Table 1 in soil

| | Disintegration in |
|---|---|
| Compositions | soil at 182 days |
| Composition 1 | gd = 5 |
| Comparative composition 1 | gd = 2 |
| Composition 3 | gd = 4 |
| Composition 4 | gd = 4 |

TABLE 5
Disintegration of films including the compositions
shown in Table 1 in home composting

| Compositions | Disintegration in home composting |
|---|---|
| Composition 2 | gd = 5 at 100 days |
| Comparative | gd = 5 at 120 days |
| composition 2 | |

As can be seen, the compositions according to the invention have a considerable effect on the disintegration kinetics.

1) A polymer composition comprising, with respect to the total composition:
i) 50-85% by weight, with respect to the sum of components i)-iv), of at least one polyester comprising:
a) a dicarboxylic component comprising, with respect to the total dicarboxylic component:
a1) 30-70% by moles of units derived from at least one aromatic dicarboxylic acid;
a2) 70-30% by moles of units derived from at least one saturated aliphatic dicarboxylic acid; and
a3) 0-5% by moles of units derived from at least one unsaturated aliphatic dicarboxylic acid;
b) a diol component comprising, with respect to the total diol component:
b1) 95-100% by moles of units derived from at least one saturated aliphatic diol; and
b2) 0-5% by moles of units derived from at least one unsaturated aliphatic diol;
ii) 0.1-50% by weight, with respect to the sum of components i)-vi), of at least one polymer of natural origin,
iii) 0.1-10% by weight, with respect to the sum of the components i)-vi), of at least one polyhydroxyalkanoate other than a polyester of lactic acid mentioned in point iv);
iv) 0-3% by weight, with respect to the sum of components i)-vi), of at least one polyester of lactic acid;
v) 0-1% by weight, weight, with respect to the sum of components i)-vi), of at least one cross-linking agent and/or chain extender and/or hydrolytic stabiliser comprising at least one compound having two or multiple functional groups including isocyanate, peroxide, carbodiimide, isocyanurate, oxazoline, epoxide, anhydride and divinylether groups and mixtures thereof, and
vi) 0-15% by weight, with respect to the sum of components i)-vi), of at least one inorganic filler.

2) The polymer composition according to claim 1) in which the aromatic dicarboxylic acids (component a1) are selected from aromatic dicarboxylic acids of the phthalic acid type and heterocyclic dicarboxylic aromatic compounds their esters, salts and mixtures.

3) The polymer composition according to claim 2) in which the aromatic dicarboxylic acids comprise:
1 to 99% by moles of terephthalic acid, its esters or salts;
99 to 1% by moles of 2,5-furandicarboxylic acid its esters or salts.

4) The polymer composition according to claim 1) in which the saturated aliphatic dicarboxylic acids (component a2) of aliphatic-aromatic polyesters i) are selected from C2-C24 saturated dicarboxylic acids, their C1-C24 alkyl esters, their salts and mixtures thereof.

5) The polymer composition according to claim 4) in which the saturated aliphatic dicarboxylic acids (component a2) of aliphatic-aromatic polyesters i) are selected from succinic acid, 2-ethylsuccinic acid, glutaric acid, 2-methylglutaric acid, adipic acid, pimelic acid, suberic acid, azelaic acid, sebacic acid, undecandioic acid, dodecandioic acid, brassylic acid and their C1-C24 alkyl esters and mixtures.

6) The polymer composition according to claim 1) in which the saturated aliphatic diols (components b1) of the aliphatic-aromatic polyesters are selected from 1,2-ethanediol, 1,2-propanediol, 1,3-propanediol, 1,4-butanediol, 1,5-pentanediol, 1,6-hexanediol, 1,7-heptanediol, 1,8-octanediol, 1,9-nonanediol, 1,10-decanediol, 1,11-undecanediol, 1,12-dodecanediol, 1,13-tridecanediol, 1,4-cyclohexanandimethanol, neopentylglycol, 2-methyl-1,3-propanediol, dianhydrosorbitol, dianhydromannitol, dianhydropyriditol, cyclohexanediol, cyclohexanmethanediol, dialkylene glycols and polyalkylene glycols of molecular weight 100-4000 and mixtures thereof.

7) The polymer composition according to claim 1) in which the saturated aliphatic diols (components b1) of the aliphatic-aromatic polyesters comprise at least 50% in moles of one or more diols selected from 1,2-ethanediol, 1,3-propanediol, and 1,4-butanediol.

8) The polymer composition according to claim 1) in which aliphatic-aromatic polyesters i) are selected from poly(1,4-butylene adipate-co-1,4-butylene terephthalate), poly(1,4-butylene succinate-co-1,4-butylene terephthalate), poly(1,4-butylene sebacate-co-1,4-butylene terephthalate), poly(1,4-butylene azelate-co-1,4-butylene terephthalate), poly(1,4-butylene brassylate-co-1,4-butylene terephthalate), poly(1,4-butylene adipate-co-1,4-butylene sebacate-co-1,4-butylene terephthalate), poly(1,4-butylene undecanoate-co-1,4-butylene terephthalate, poly(1,4-butylene dodecanoate-co-1,4-butylene terephthalate, poly(1,4-butylene azelate-co-1,4-butylene sebacate-co-1,4-butylene terephthalate), poly(1,4-butylene adipate-co-1,4-butylene azelate-co-1,4-butylene terephthalate), poly(1,4-butylene succinato-co-1,4-butylene sebacate-co-1,4-butylene terephthalate), poly(1,4-butylene adipate-co-1,4-butylene succinato-co-1,4-butylene terephthalate), poly(1,4-butylene azelato-co-1,4-butylene succinato-co-1,4-butylene terephthalate) and mixtures thereof.

9) The polymer composition according to claim 1) in which aliphatic-aromatic polyesters i) comprise repetitive units derived from at least one hydroxy acid in quantities between 0 and 49% in moles with respect to the total moles of the dicarboxylic component.

10) The polymer composition according to claim 1) in which polyester i) has a molecular weight ≥20000, a polydispersity index of molecular weights Mw/Mn of between 1.5 and 10, and inherent viscosity greater than 0.3 dl/g measured using an Ubbelohde viscometer for solutions of concentration 0.2 g/dl in CHCl3 at 25° C.

11) The polymer composition according to claim 1) in which the content of polyester terminal acid groups i) is preferably less than 100 meq/kg.

12) The polymer composition according to claim 1) in which component ii), a polymer of natural origin, is selected from starch, chitin, chitosan, alginates, proteins.

13) The polymer composition according to claim 1) in which the polyhydroxyalkanoate is selected from poly-F-caprolactone, polyhydroxybutyrate (PHB), polyhydroxybutyrate-valerate (PHBV), polyhydroxybutyrate propanoate, polyhydroxybutyrate-hexanoate (PHBH), polyhydroxybutyrate-decanoate, polyhydroxybutyrate-dodecanoate, polyhydroxybutyrate-hexadecanoate, polyhydroxybutyrate hexadecanoate, polyhydroxybutyrate-octadecanoate, and poly3-hydroxybutyrate-4-hydroxybutyrate.

14) The polymer composition according to claim 1) in which the polyhydroxyalkanoate is further characterized in that the hydroxybutyrate co-monomer is higher than 95% by moles with respect to the sum of all the co-monomers

15) The polymer composition according to claim 14) in which the polyhydroxyalkanoate is selected from polyhydroxybutyrate (PHB), and polyhydroxybutyrate-valerate (PHBV).

16) The polymer composition according to claim 1) in which the polyester of lactic acid (component iv) is in quantities from 0 to 2.9% by weight with respect to the sum of components i)-vi).

17) The polymer composition according to claim 1) in which the crosslinking agent and/or chain extender is selected from mixtures of compounds having two or multiple functional groups including isocyanate groups with compounds having two or multiple functional groups including epoxy groups.

18) The polymer composition according to claim 1) in which the inorganic filler (component vi) is selected from kaolin, barytes, clay, talc, calcium and magnesium carbonates, iron and lead carbonates, aluminium hydroxide, diatomaceous earth, aluminium sulfate, barium sulfate, silica, mica, titanium dioxide, wollastonite and mixtures thereof.

19) The polymer composition according to claim 1) comprising, in addition to components i)-vi), one or more polymers other than biodegradable and non-biodegradable components i)-iv) of synthetic or natural origin.

20) The polymer composition according to claim 1) comprising, in addition to components i)-vi), plasticisers, UV stabilisers, lubricants, nucleating agents, surfactants, antistatic agents, pigments, flame retardants, compatibility agents, lignin, organic acids, antioxidants, mould-preventing agents, waxes, process aids and polymer components selected preferably from the group consisting of vinyl polymers, diacid-diol polyesters other than the aliphatic-aromatic polyester described above, polyamides, polyurethanes, polyethers, polyureas, polycarbonates.

21) A film comprising a polymer composition according to claim 1.

22) The film according to claim 21 characterised in that it has a thickness of less than 40 μm.

23) The film according to claim 21 characterised in that it has a tensile strength >15 MPa elongation at break >200%, elastic modulus >200 MPa, determined according to standard method ASTM D882 (tensile properties at 23° C. and relative humidity of 55% and Vo=50 mm/min).

24) The film according to claim 21) characterised by tear strength in the machine direction >80 N/mm, tear strength in the transverse direction >150 N/mm (determined according to ASTM D1922 at 23° C. and 55% relative humidity).

25) The film according to claim 21) selected from:
film, both mono- and bi-oriented, and multi-layer film with other polymer materials;
film for use in the agricultural sector as mulch films;
fabric for use in the agricultural sector as an agricultural textile;
stretch film for food, for baling in agriculture and for wrapping waste;
films for use in the hygiene sector.

26) An article produced with polymer compositions according to claim 1 selected from:
bags and liners for organic collection such as the collection of food waste and grass cuttings;
bags for fruit and vegetables and shopping bags;
composites with gelatinised, destructured and/or complexed starch, natural starch, flours, or other natural, vegetable or inorganic fillers, as filler.
